(19) United States
(12) Patent Application Publication
(10) Pub. No.: US 2004/0135677 A1
(43) Pub. Date: Jul. 15, 2004

(54) Use of the data stored by a racing car positioning system for supporting computer-based simulation games

(76) Inventor: Robert Asam, Hallbergmoos (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/297,939

(22) PCT Filed: Jun. 26, 2001
(86) PCT No.: PCT/EP01/07284

(30) Foreign Application Priority Data
Jun. 26, 2000 (DE) 100 31 026.5

(51) Int. Cl. B60Q 1/00

(52) U.S. Cl. 340/425.5; 340/988; 701/200; 701/35

(57) ABSTRACT

Data obtained and preferably stored or buffered by the positioning system for racing cars according to an older, separate application PCT/EP00/10518 is used to support computer-based simulation games, The reference data obtained in such a way forms marginal conditions for the computer simulation game. The use of the positioning system, or the data obtained thereby, opens up the possibility of providing such simulation games with an as yet unachieved realistic touch. The real-time axis of the racing course, for example, or the real driving condition data and operating data pertained to the racing cars during the real finished or ongoing race are entered as marginal conditions for the simulation game. Tis data can be made compatible with the simulation immediately by means of appropriate interface software.

### DESCRIPTION

The present invention Concerns a positioning system for racing vehicles, in particular for use with Formula One races, and in particular with reference to the use of data gathered by such a positioning system in the course of a race.

Sports races with various race vehicles have been known and popular for centuries. Their popularity has often led to the development and use of special vehicles for the type of race, of racetrack improvements, driving techniques etc. There are always new developments that provide increased safety, information to the public and increased racing speed or the like.

U.S. Pat. No. 5,731,788 shows a system and procedure to control the positioning and manage the positions and speeds of racing yachts that encompasses the strategic placement of GPS receivers and transmitters on a buoy and a committee boat marking the starting line for yacht races, as well as the radio and GPS receivers on the yacht, GPS and radio transmitter units are attached to a buoy at the starting line of the race and a committee boat and another GPS and radio transmitter unit receives GPS signals from positioning satellites and radio signals from the starting buoy and the committee boat. The information received by the racing yacht is processed in order to determine, the relative and absolute positions and speeds as well as the estimated arrival time back at the starting line of the race at the average current yacht speed for display on a user-friendly race control screen.

Another example is U.S. Pat. No. 3,724,649 that shows a racecar monitoring system that represents a completely automated system to monitor a race or the like. Each vehicle carries a transponder that calculates when it passes a certain position event, for example the crossing of the starting/finishing line, the entry or exit from the box area etc., and that transmits the respective signal to a receiver on the side of the track next to the position event in a time-multiplex process with the transponders of all other vehicles. A main transmitter transmits a synchronization signal that is divisible time-wise to all vehicle transponders and each transponder is designed to transmit a position event signal only during a specified time segment of the synchronization signal. The receivers at the side of the racetrack feed into a central control unit that is also synchronized with the main transmitter and that records the appearance of the position events of each vehicle in real time. A clock and a computer are provided to be able to determine the race rank, the rotation speeds etc, from the recorded data. The system for recognizing a position event is based on the principle that an inductance carried in the vehicle crosses a changeable magnetic field, the polarity orientation of which defines the position of the respective event.

Furthermore, U.S. Pat. No. 4,949,067 shows a race danger warning system that encompasses a transmitter activated by a track surveyor or other race official as well as a sufficient number of receiver units so that each racing vehicle has a receiver unit. The transmitter sends a coded signal that can be received anywhere along the racetrack depending on the status of a red, yellow or green flag. The receiver units that are self-contained and include a built-in power supply receive and decode the signal and subsequently switch on green, yellow or red lamps. The system essentially alerts the race participants to an imminent danger situation on the racetrack.

In our own, previous patent application PCT/BP00/10158, whose content is included in the present application, a positioning system for racecars is proposed that offers an increased functionality, simpler control and increased safety compared with the current state of the art. Other advantages of the invention are explained in detail below.

Important characteristics of this positioning system are indicated in claims 6 to 20.

In essence such a positioning system according to a first embodiment consists of a vehicle information device installed in a racecar, and which includes a positioning device for the collection and output of position data through which the position of the racing vehicle can be determined, and a transmitter that sends the position data to a control center. This ensures a cost-effective and reliable determination of the vehicle position. In particular it avoids the possibility of confusing the various racecars as each racecar determines and reports its own position data. In addition the transmitter can also be used to send further data to the control center.

For an advantageous embodiment of the invention a plurality of such vehicle information devices is operated in combination with a computation unit that calculates the position of the various vehicles on the track from the position data with the help of stored racetrack data. Through the virtual display of the race course in the form of racetrack data the respective positions of the racecars can be calculated using the transmitted position data without the need to install position-calculating devices at all important points of the racetrack. It is even possible to determine when a vehicle exits the racetrack or is stalling on the track and to pinpoint its position precisely without additional effort.

The track data may be reused if stored in a professional manner; however, in case the track changes they can also be updated either in part or in full as needed. Even the transfer of the track data to another positioning systems is feasible.

Any professional knows that positioning data can be collected in a vehicle in many ways. For example the vehicle can be equipped with a GPS receiver (GPS “Global Positioning System,” a global, satellite-supported navigation system) or other satellite receiver, a localizing receiver or a gyrosensor. It is also possible to use a redundant combination of such receivers or sensors. If necessary the various racing vehicles can also be equipped with different positioning devices to collect the position data. In case a localizing receiver is used it is necessary to complete the positioning system with at least three localizing transmitters along the racetrack the positions of which are known exactly. By measuring the distance between the localizing transmitters and the respective localizing receiver the position of the latter can be determined

As already mentioned above, the transmitter provided in the vehicle information device can also be used to transmit vehicle-operating data, for example vehicle speed, engine rotations and similar data, Such data are collected through respective sensors or from the electronic system of the vehicle and help in quickly recognizing a stall or other dangers the racecar might be in. In order to prevent an abuse of the positioning and operating data, the data can be transmitted partially or fully encoded in a known manner. Even for this advantageous characteristic of the invention it is not necessary to equip the various vehicle information devices or racecars in the same way.

The positioning system preferably includes a control center that has the above-mentioned computation unit, a memory to store the track data of the racetrack and one or more receivers to receive the positioning and operating data sent by the various vehicle information devices. In such a case the system components that do not necessarily have to be separated in space can be designed as individual components, as partial groups or as an integrated total unit.

It is also of advantage if the control center has a transmitter that can be used for sending safety data and if one or more racecars that are part of the positioning system have the respective receivers and display devices in order to, if need be, receive the safety data and display them. This would make it thus possible, for example when it is determined via the positioning system under this invention that a racecar has stalled, to emit and signal a warning analogous to the green, yellow and red flags used for Formula One races to the other racecars that are part of the positioning system,

In particular the receivers mounted in the racecars can also be provided with an ID code that would allow the control center to selectively address the respective receiver. In this way it is possible to differentiate between the racecars that are part of the positioning system depending on the danger situation, For example racecars that will reach the danger spot only after a prolonged time would have a green signal while racecars that will pass the danger spot shortly would have a “red” signal. The other vehicles would have a “yellow” signal. Other professionally practiced differentiation methods, for example the time and frequency multiplex operation, may also be used here to make it possible to selectively address the various racecars.

In order to circumvent the need of having all racecars take part in the positioning system or to guarantee further track safety, the track monitoring posts normally set up at race events may also be part of the positioning system by equipping one or more of them also with receivers and display units that receive and properly display the transmitted safety data. Again, by using an ID code or something similar, it is possible to selectively contact the respective track monitoring post possible. For security reasons the safety data can be fully or partially coded in a professional manner,

Preferably the positioning system as per invention includes a representation device that gives a visual display of the actual positions of selected racecars on the racetrack via the track data and the computed vehicle positions. If necessary this task can be taken over by the computation unit so that no additional hardware is needed for the representation device. For example the computation unit could process the collected position information together with the track data Into a video signal that Is transmitted to the television stations transmitting the race. The representation device however may also include one or more large screens or video screens that present the attending public with a visual display of selected vehicle positions. This results in a system that, aside from the advantages related to safety, also has the special benefit that the spectators-irrespective of where they are-can be kept informed about the race situation on the entire track in real time, thereby substantially increasing the attractiveness of a visit to the racetrack.

The representation unit can also include a data processing device that allows, among other things, a visual display of the actual positions of selected racecars along the racetrack on displaying data processing devices, which for example are networked via a fixed network or a radio connection with the data processing device for the purpose of data transmission. This would allow for example the virtual transmission of the race on the Internet. Also other race data captured by the positioning system per this invention, for example the respective ranking or the actual speed of selected racecars could be called up or displayed through such a data-processing device integrated into the positioning system and the respective networking on the displaying data-processing devices. The data-processing device is integrated into the positioning system in such a manner that the relevant race data contained in the positioning system can be prepared and processed by the data-processing device for the professional input into a data network in a way that an intended audio and/or visual presentation of the race or the desired race data on the respective displaying data-processing device is feasible. Moreover, the respective representations of a plurality of displaying data-processing devices can differ from one another. For example, a cell phone functioning as a displaying data-processing device could show only the respective ranking and the lead of selected racecars, while a computer networked via the Internet with a data-processing device could present a virtual display of the race on the screen, e.g. the actual positions of randomly selected racecars along the racetrack, Preferably the desired mode of representation or the information to be shown is selected by interactive input by the user of the displaying data-processing unit and the data-processing device.

All or selected components of the positioning system as per this invention are preferably designed with a redundancy to guarantee the functionality of the positioning system even if one or more components fail This is above all true for the safety-related components of the positioning system, for example the computation unit.

Alternatively the positioning system can be executed in a second embodiment in such a way that the respective vehicle information devices have only a transmitter for sending localizing signals instead of the positioning device and the transmitter. With the help of at least three spatially separated localizing receivers included in the system, position data can therefore be collected outside of the vehicle and transmitted to the control center where they are processed by the computation unit as described above. Since the localizing receivers can be connected to the control center e.g. via cables, there might be no need for a receiver at the control station. All other characteristics of the invention are the same as for the first embodiment.

It is also possible to use this second embodiment only for selected racecars or that the two embodiments of the invention coexist among the participants in the race.

The intent of this invention is to make use of the positioning system, which as shown above has special advantages, in a beneficial way for other applications,

This task is accomplished by the characteristics of claim 1. Beneficial variants are the subject of the sub-claims.

According to the invention the data collected by the positioning system pursuant to the preceding proprietary application PCT/EP00/10518, and preferably put in storage or intermediate storage, are used to support computer-aided simulation games. The reference data therefore provide the framework for the computer simulation game. This use of the positioning system and the data collected thereby per this invention opens up the possibility to give such simulation games a degree of reality not achieved until now, for example by inputting the real time axis of the actual race or the real driving conditions and operating data of the racecars during the actually performed or ongoing race as framework for the simulation game, The data can be made compatible with the simulation via a suitable interface software without any problems.

The data can be input into the simulation game as reference data in unprocessed or also in processed form, whereby a suitable interface or interface software again ensures compatibility of the data set with the simulation game. Within the framework of this data processing the time axis of the data can for example be extended so that the data can be used also quite well for inexperienced users.

Simply by the fact that the position data taken in by the positioning system normally also include the altitude data of the race course, the simulation game can be made much more real to life. A further improvement can be achieved by allowing the operating data of the vehicles to flow into the simulation, making it possible for the first time in a simulation game to drive a course against other comparable vehicles in real time in such a way that the maneuverability of the vehicle is also taken into account.

Examples for the embodiment of a positioning system whose data are used as reference data for a computer simulation are described in more detail with the use of drawings. These show:

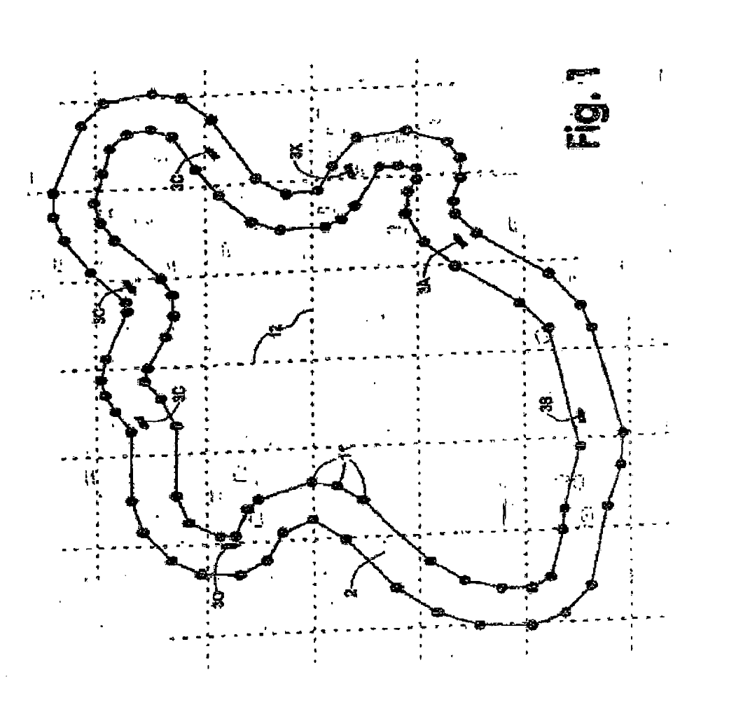

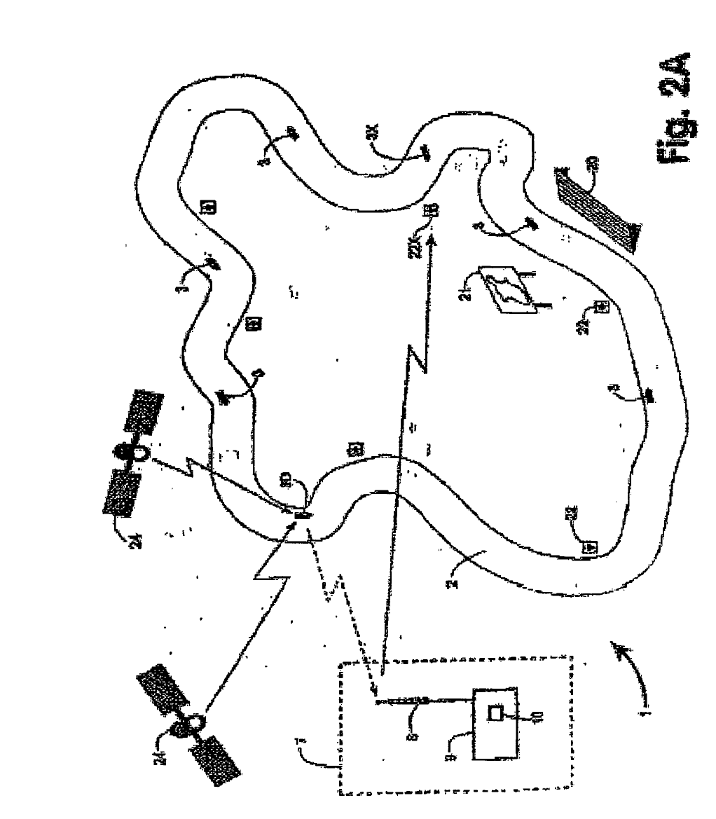

FIG. 1 The rendition of a racetrack through track data according to a preferred example for the embodiment of the invention;

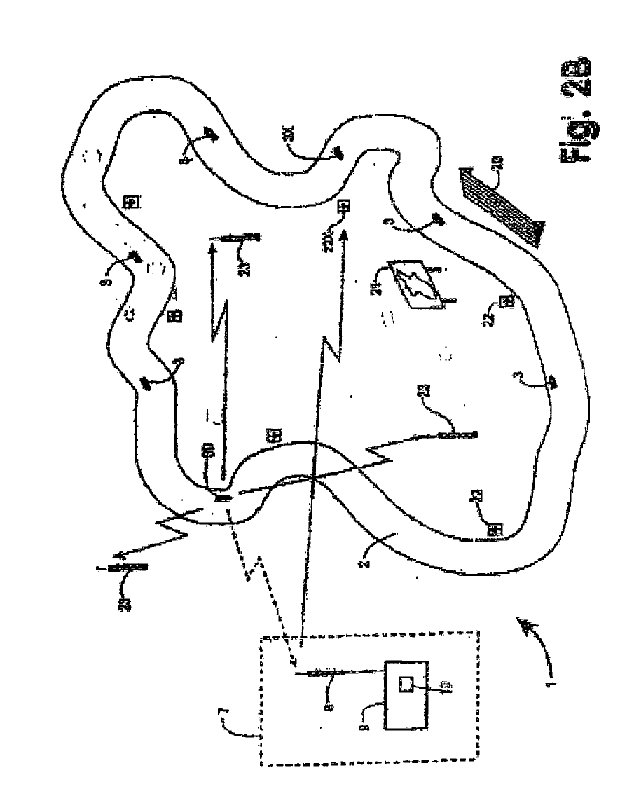

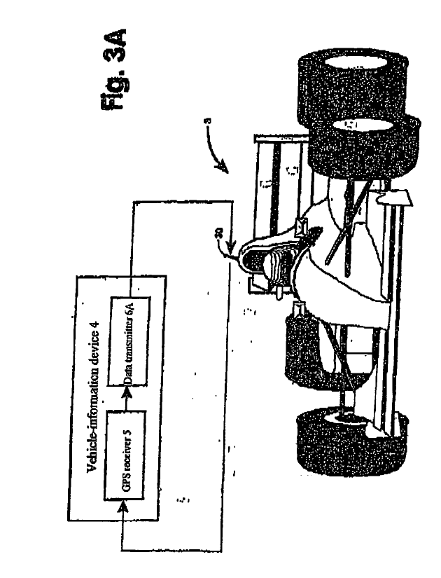

FIG. 2A A racetrack with a positioning system according to a preferred example of embodiment of the invention following the first embodiment;

FIG. 2B A racetrack with a positioning system according to a preferred design example of the invention following the second design;

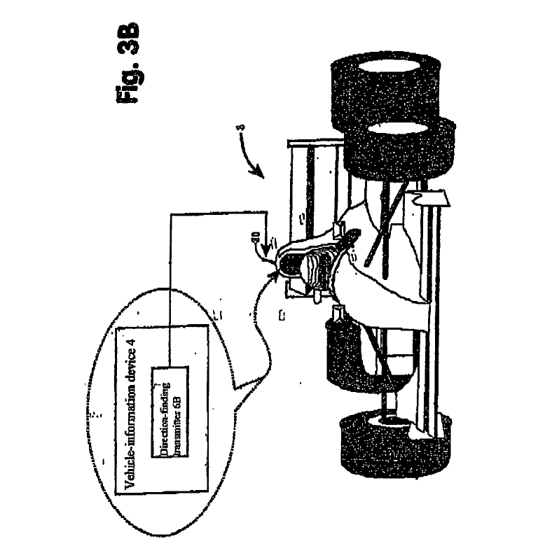

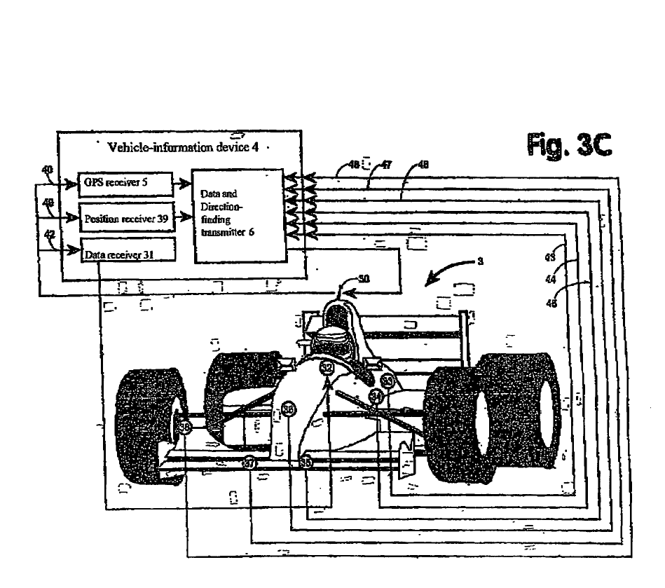

FIG. 3A A racecar with a vehicle information device according to a first example of embodiment following the first embodiment;

FIG. 3B A racecar with a vehicle information device according to a first example of embodiment following the second embodiment;

FIG. 3C A racecar with a vehicle information device according to a second example of embodiment;

FIG. 1 shows the rendition of a racetrack 2 through track data according to an advantageous embodiment example of a positioning system 1 as per the invention, It shows a plurality of vehicles 3A, 3B, 3C and 3×located on a racetrack 2 that are part of the positioning system.

In order to be able to calculate the position of one or more of the racecars 3 on racetrack 2, the racetrack 2 is stored in positioning system 1 in the form of track data presented in such a way that a comparison of the track data with the position data received from the respective racecars 3 is possible. This comparison is carried out in a computation unit 9 of the positioning system, for example a digital EDP facility. Accordingly, the track data are stored preferably in a professional manner in a storage device of the computation unit 9. It is also possible to store the track data in a storage device (10) connected with the computation unit 9 or to store the track data in a data memory that is read by a reading device taking the place of the storage device (10).

According to the example of embodiment shown in FIG. 1, the racetrack 2 is rendered through orderly sequences of points 11 that are measured in a fixed system of coordinates 12 and that function as track data Connection the points 1 in sequence with straight-line segments defines therefore the inner and outer delimitation of the track 2. In this way it is possible to render any desired two-dimensional track topology. Moreover, with the points 11 or the point sequences individual track segments and also the indicated direction can be defined or recognized. However, other ways to render the track that are known to professionals are of course also possible.

In the example of embodiment shown in FIG. 1 the racecars 3 are located with the help of the system of coordinates 12. However, since the comparison of coordinate data between different systems of coordinates requires only a mathematical transformation, the position data of the respective racecars 3 can also be determined on the basis of other systems of coordinates. This could for example occur if some racecars are located via GPS receivers while the position data of other racecars 3D are determined through localizing receivers of a locally installed localizing system 23.

The figure assumes and indicates that the racecars 3 are moving counterclockwise on racetrack 2. If it is also assumed that the racecar 3X represents a stalled vehicle then racecar 3A is very close to the danger spot. The racecar 3B still has a safe distance to the immediate danger zone while according to the rendition there is no immediate danger for racecar 3C. A stalled racecar 3 can be recognized by the fact that its position basically does not change anymore. By identifying the affected track segment and the respective positions of the remaining racecars 3A, 3B, 3C participating in the positioning system 1, the respective individual danger level for the remaining vehicles 3A, 3B, 3C can be determined.

The FIGS. 2A and 2B show several characteristics of a positioning system 1 according to an advantageous, example of embodiment following the first or second embodiment of the invention. Shown is a racetrack 2 on which are several racecars 3 participating in the positioning system 1 as well as two GPS satellites 24. Along the racetrack 2 there are several track monitoring posts 22, a spectator stand 20 and a large video screen 21, with the former and latter being part of the positioning system 1 of the example. In the figures the positioning system 1 also includes a control center 7, a transmitter-receiver facility 8 and a computation unit 9. In FIG. 2B the positioning system 1 also includes three localizing receivers 23.

In FIG. 2A according to the first example of embodiment of the invention the racecar 3D has a GPS receiver as positioning device 5 that receives radio signals from GPS satellites 24. From these signals the GPS receiver or another suitable positioning device in racecar 3 gets position data through which the actual position of racecar 3 can be determined. The collected position data are transmitted via a transmitter 6 in racecar 3 to a control center 7 that has a receiving device assigned to transmitter 6. Accordingly the respective transmitters 6 of the racecars 3 and the control station 7 of the preferred embodiment example shown in FIG. 2A form a star-shaped network, Together the positioning device 5 and the transmitter 6 in racecar 3 form a vehicle information device 4.

In FIG. 2B according to the second embodiment of the invention the position of the vehicle 3D is determined through a localizing transmitter 6B mounted in vehicle 3D, through the at least three localizing receivers 23 set up close to racetrack 2 and the computation unit included in the control center 7. The localizing transmitter 6B emits localizing signals that are received by the localizing transmitters [TN: should probably be receivers], processed and retransmitted as position data to the control center 7, where they serve to determine the position of vehicle 3D in the computation unit. The position data can be transmitted in known fashion, for example per cable, from the localizing receivers 23 to the control center. This might obviate the need of a receiver 8 in the control center 7. In the example of embodiment shown the receiver 8 serves to receive vehicle operating data or redundant position data from a data transmitter 6A installed in the vehicle, which are preferable used for monitoring the position or the operating condition of the racecar 3D.

Per the invention each racecar 3 participating in the positioning system 1 has a vehicle information device 4, which however may be designed according to different working principles. The steps described above for collecting position data and for calculating the position of a racecar 3 are also carried out mutatis mutandis for other vehicles.

In a computation unit 9, which includes a memory 10, assigned to the control center 7, the position of the racecar 3 along racetrack 2 is calculated from the position data with the help of the track data stored in memory 10. The position calculated in this way indicates the ranking of racecar 3 among the racecars 3 participating in the positioning system 1 and also whether the racecar 3 has stalled, is driving dangerously slowly or has left the racetrack 2.

The FIGS. 2A and 2B for example indicate that the vehicle 3×participating in the positioning system has stalled. Based on the position information collected from computation unit 9 such a stall is determined preferably in control center 7 by the computation unit 9 or a device connected with the computation unit 9. Subsequently a message is sent via the transmitter-receiver unit 8 to the racecars 3 and/or the track monitoring posts 22. For security reasons the data per the invention are preferably sent by the transmitter-receiver unit 8 in coded form, Since the position of the stalled racecar 3X is known, it is possible to send a targeted message to the track monitoring post 22X closest to the racecar 3X using an ID code or some other professionally practiced discriminating signal. It is also possible to send a message to racecars 3C that differs from the message to racecars 3B or 3A. As mentioned above, depending on the danger level, vehicle 3A can be sent a “red light” signal while the racecar 3B receives a “yellow light” and the vehicles 3C a “green light” signal, which are then displayed accordingly in the respective vehicles 3, By the same token the danger could be communicated via display devices at the track margin, for example by a movable flag or a traffic light display.

The FIGS. 2A and 2B show a large video screen 21 that is part of the positioning system, making a visual display of the actual vehicle positions of selected racecars 3 along racetrack 2 possible. The large video display 21 is fed by signals generated in the computation unit 9 or another representation device using the positions calculated in computation unit 9 and the stored track data as described above. Identical or similar data can also be fed to a television station or other transmission services such as an Internet provider for retransmission, The representation does not have to be limited to a display of the vehicle position but can include information about the respective vehicles 3 or other race or advertising information,

The position information of the participating racecars 3 collected with the help of the positioning system 1 per the invention can also be used to point or train television or monitoring cameras along track 2 automatically at one or more selected vehicles 3, It also could show automatically the picture of the camera that has the best view of a selected racecar 3. A professional will easily recognize several other usable variations of this principle.

The vehicles participating in the race require only a slight adaptation or upgrade. FIGS. 3A, 3B and 3C show various design examples of the two embodiments for a racecar 3 equipped per the invention. Per the invention the vehicles 3 have an antenna 30 and a vehicle information device 4, which are mounted in or on the vehicle in a professionally acceptable manner. The latter is indicated in FIG. 3B with broken lines.

FIG. 3A shows a racecar with a stripped-down vehicle information device 4 according to the first embodiment of the invention in which the vehicle information device 4 includes only the essential components. As such the vehicle information device 4 has only a positioning device 5 and a transmitter 6.

In the shown embodiment example a GPS receiver 5 functions as a positioning device 5 and a data transmitter 6A plays the role of the transmitter 6. GPS radio signals are transmitted by a GPS satellite 24 to the GPS receiver via the antenna 30, where they are processed into position data. The position data are processed in the data transmitter 6A and relayed to the antenna 30 from where they are sent to a receiver 8 in the control center 7. Professionals know that the assignment of tasks to the components 5, 6 included in the vehicle information device 4 can, if necessary, also be structured differently, As mentioned above, per the invention other positioning devices 5 and transmitters 6 can also be used.

FIG. 3B shows a racecar with a stripped-down vehicle information device 4 according to the second embodiment of the invention in which the vehicle information device 4 includes only the essential components. As such the vehicle information device 4 has only a localizing transmitter 6B that sends localizing signals via the antenna 30 to the respective localizing receivers 23 where they are analyzed as described above.

Per the invention, the respective vehicle information devices 4 of the vehicles 3 participating in the positioning system can be connected to or even include one or more other devices 33-39 that transmit vehicle operating data or redundant position data to the transmitter 6 directly or via the vehicle information device 4 in order to relay these operating data or position data to the control center 7. FIG. 3C shows a vehicle 3 equipped with many different additional devices. These additional devices 33-39 per the invention can be different for the respective vehicles 3, The kind of additional devices for the respective racecars 3 depends, among other things, on the weight of the devices 33-39 as well as on their cost and need for space.

The racecar 3 of the embodiment example shown in FIG. 3C corresponds both to the first and second embodiment of the invention as the shown vehicle information device 4 has a localizing transmitter 6 as well as a positioning device 5 and a transmitter 6. This allows for a redundant positioning of the vehicle through the positioning system per the invention.

The shown vehicle information device 4 uses an optional GPS receiver 5 as positioning device 5. Via the antenna 30 or a separate antenna the GPS receiver 5 receives GPS signals 40 from GPS satellites 23 and derives from them GPS positioning signals that are relayed to the data transmitter 6 for retransmission to the control center 7. Even though it is known that GPS data collected in this fashion are defective, no correction is necessarily needed per the invention since the defect is visited upon all vehicles 3 participating in the positioning system in the same way. If necessary a GPS receiver can be installed in the control center 7 whose GPS data are compared to the fixed, known position of the control center in order to calculate a correction vector for the GPS data derived from the vehicles 3.

For the redundant positioning of the racecar 3 the shown vehicle information device 4 has, among other things, additionally a localizing transmitter 6 that sends localizing signals to the localizing receivers 23 set up close to the racetrack 2 via the antenna 30 or a separate antenna. As described above, at that point position data for use in the control center 7 are derived from the localizing signals. If necessary the task of the localizing transmitter 6 is taken an by the data transmitter 6 or the two transmitters 6 are designed as an integral unit.

The shown racecar 3 includes as additional equipment a engine rotation sensor 33, a gear sensor 34, a ground movement sensor 35, a gyrosensor 36, an induction loop sensor 37, a wheel rotation sensor 38 and a position receiver 39, The gyrosensor 36 measures the speed of the vehicle 3 via a piezoelectric element built into the gyrosensor 36 and provides position data based on the acceleration measurements. The engine rotation sensor 33 and the wheel rotation sensor 38 measure the rotational velocity of the motor or of one of the wheels in the usual manner and yield the respective data, preferably in the form of a pulse information or other digital data. The ground movement sensor 35 uses infrared, ultrasound or radar signals to measure the speed of the vehicle 3 and output it in the respective data form. The gear sensor determines the output speed of the gears and reports it also in data form. The passing of induction loops traditionally embedded in the race surface can be measured via the induction loop sensor 37 in order to collect position data. It is also possible to set up position transmitters with small apertures along the racetrack that send position signals 49 in the respective local area. The position signals 49 are received via the antenna 30 or a separate antenna by the position receiver 39 that processes the position signals 49 into position data and relays them to the data transmitter 6 for retransmission to the control center 7.

According to the shown embodiment example the data tom the respective sensors or devices 33-38 are relayed to the data transmitter 6 as data signals 43-48 for retransmission to the control center 7. As indicated in FIG. 3C, if necessary selected data signals of the data signals 43-48 are relayed to the data transmitter 6 only after having been processed in the vehicle information device 4. For security reasons the data per the invention are preferably sent to the transmitter 6 in encoded form.

The shown vehicle information device 4 includes also a data receiver 31 that receives safety and data signals 42 preferably from the control center 7 via the antenna 30 or a separate antenna.

The signals 42 are processed accordingly in data receiver 31 or in the vehicle information device 4 to implement, if necessary and as mentioned above, a warning display or other display via a display device, for example in the form of a cockpit indicator lamp 32 on the instrument panel.

Per the invention the respective components of the vehicle information device 4 and/or sensors 33-38 are attached on board the vehicle 3 in a suitable place and are connected or networked with each other or with the transmitter 6 in a professionally accepted manner that preserves the intended functionality. Professionals know that the assignment of tasks between the components included in the positioning system per the invention can, if necessary, also be structured differently.

Aside from determining the speeds, acceleration values, sense of rotation and velocity of movement the data collected by the physical sensors 33-38 are also compared as to whether there is a relationship between the calculated values in their mutual interplay that makes sense for an orderly forward movement of the vehicle 3. If the output speed of the gears for example is disproportionately higher than the wheel speed one can immediately say that there is a differential defect, and if the wheel speed is disproportionately higher than the forward movement speed as measured above ground, one can immediately diagnose that the wheels are spinning. Together with the results of the accelerator sensor 36 and possibly the GPS receiver 5 this allows verifying a deviation from the admissible movement tolerance range not only in absolute values but also with redundant additional information.

With the collected data of the GPS positioning device 5 and the physical sensors it is possible, with a high degree of assurance, to verify the correct or defective movement of the vehicle 3 on the racetrack 2 in the direction of the course, The data collected with the help of the described sensors or other professionally accepted sensors or devices can be used in the control center 7 to identify a possible stall, the position, speed and other data of a racecar 3 participating in the positioning system.

In order to use the positioning system described above in an advantageous manner for other applications, the data that were collected through the positioning system described above and were preferably put in storage or interim storage can be used to support computer-aided simulation games. In this case the reference data form the framework conditions for the computer simulation. This use of the positioning system and the data collected with it opens up the possibility to give such simulation games a degree of reality not achieved until now, for example by inputting the real time axis of the actual race or the real driving conditions and operating data of the racecars during the actually performed or ongoing race as reference conditions for the simulation game. The data can be made compatible with the simulation via a suitable interface software without any problems.

The data can be input into the simulation game as reference data in unprocessed or also in processed form, whereby a suitable interface or interface software again ensures compatibility of the data set with the simulation game. Within the framework of this data processing the time axis of the data can for example be extended so that the data can be used also quite well for inexperienced users.

Simply by the fact that the position data taken in by the positioning system normally also include the altitude data of the race course, the simulation game can be made much more real to life. A further improvement can be achieved by allowing the operating data of the vehicles to flow into the simulation, making it possible for the first time in a simulation game to drive a course against other comparable vehicles in real time in such a way that the maneuverability of the vehicle is also taken into account.

The professional has many devices at his disposal to collect, process, transmit and/or analyze the position and operating data within the framework of the claimed invention. For example by using a frequency or time multiplex signal or a corresponding ID code for the transmitted data, the data of the respective racecars 3 can be differentiated.

Therefore the embodiment and application examples of the invention that are explained in the description serve only as an example for what the professional understands or could understand as equivalent in the respective context and that be could possibly use instead of one of the listed examples. Such equivalents are therefore as much part of the invention as the explicit, not all-comprehensive examples.

1. The use of the position and/or operating data of a positioning system (1) for racecars on a racetrack, preferably recorded for the fill race distance, using at least one racecar as reference data for a computer simulation game.

2. The method according to claim 1, characterized by the fact that the reference data in processed form are used by a computer simulation game.

3. The method according to claim 1 or 2, characterized by the fact that the position data of the positioning system include the altitude data of the course.

4. The method according to one of the claims 1 to 3, characterized by the fact that the reference data are transmitted via a network such as via the Internet for use in a game embodiment.

5. The method according to one of the claims 1 to 4, characterized by the fact that the reference data are processed via an interface for use in a game application.

6. The method according to one of the claims 1 to 5 in connection with a positioning system (1) with
a plurality of racecars (3), whereby each racecar (3) has a vehicle information device (4) that includes
a vehicle information device (4) that includes [sic]
a positioning device (5) to collect and output position data that allow the determination of the position of the vehicle (3) and
a transmitter (6) that transmits the position data, and
a control center (7) that has
at least one receiver (8) for receiving the transmitted position data,
one storage device (10) to store the track data (11) of the race track (2), and
one computation unit (9) that calculates the position of the racecars (3) on the racetrack (2) from the received position data of the respective racecars (3), and on the basis of the stored track data (11).

7. The method according to one of the claims 1 to 5 in connection with a positioning system (1) with
a first plurality of racecars (3), whereby each racecar (3) has a vehicle information device (4) that includes a transmitter (6) that sends localizing signals;
at least three localizing receivers (23) that collect and relay position data with the help of emitted localizing signals through which the position of the respective vehicle (3) can be determined;
a control central (7) that has
a storage device (1) to store track data (11) of the racetrack (2), and
one computation unit (9) that calculates the position of the racecars (3) on the racetrack (2) from the relayed position data of the respective racecars (3), and with the help of the stored track data (I l).

8. The method according to claim 7 in connection with a positioning system (1) with
a second plurality of racecars (3), whereby each racecar (3) of the second plurality has a vehicle information device (4) that includes a
positioning device (5) for the collection and output of position data that allow the determination of the positions of the vehicle (3), and
a transmitter (6) that sends the position data, whereby
the control center 7 has at least one receiver (8) to receive the transmitted position data, and
the computation unit (9) that calculates the position of the racecars (3) on the racetrack (2) for the second plurality from the received position data of the respective racecars (3), and with the help of the stored track data (11).

9. The method according to claim 8, in which the first and second plurality of racecars (3) match in part or in fill.

10. The method according to one of the claims 6 to 9, whereby the positioning device (5) collects the position data via a receiver of satellite-supported position data and/or a localizing receiver and/or a gyro sensor.

11. The method according to one of the claims 1 to 10, whereby at least one of the racecars (3) has at least one device (33-38) for the collection of vehicle operating data and/or position data that are transmitted to the control center (7) via the vehicle information device (4).

12. The method according to one of the preceding claims characterized by the fact that the position and operating data are fully or partially encoded for transmission.

13. The method according to one of the preceding claims, whereby
the control center (7) includes a transmitter (8) that transmits safety data and
at least one of the racecars (3) includes
a receiver that receives the safety data from the control center (7), and
a display that if necessary displays a warning based on the safety data.

14. The method according to one of the preceding claims with track monitoring posts (22), whereby at least one track monitoring post (22) has
a receiver that receives safety data from the control center, and
a display that if necessary displays a warning based on the safety data

15. The method according to one of the preceding claims, whereby in case of a stalled vehicles (3X) safety data are sent out by the control canter (7) that allows for a display of a warning in those vehicles (3A, 31B, 3C) or vehicle monitoring posts (22X) that are in a certain track segment.

16. The method according to one of the claims 13-15, whereby the safety data are determined with the help of the calculated position or the operating data of at least one of the racecars (3).

17. The method according to one of the preceding claims with a representation device (9, 21) that allows for a visual display of the actual position of one or more racecars (3) on the racetrack (2) via track data (11) and the vehicle positions.

18. The method according to one of the preceding claims with a data-processing device that processes selected racing data contained in the positioning system and inputs them into a network in such a way that a representation of these racing data on the displaying data-processing devices networked with the data-processing device is feasible.

19. The method according to claim 18, whereby the data-processing device and the displaying data-processing device are networked via the Internet.

20. The method according to claim 18 or 19, whereby the data-processing device permits the preferably interactive selection of the respective racing data to be represented and the respective mode of representation by the user of the respective displaying data-processing devices and carries out the necessary processing.
